(19) United States
(12) Patent Application Publication
(10) Pub. No.: US 2014/0123163 A1
(43) Pub. Date: May 1, 2014

(54) MANAGING DISPLAY OF CONTENT IN A CONTENT FEED

(71) Applicant: INTERNATIONAL BUSINESS MACHINES CORPORATION, Armonk, NY (US)

(72) Inventors: Kobina K. Inkumsah, Lansing, MI (US); Adam J. Parker, Cary, NC (US); Adrian X. Rodriguez, III, Durham, NC (US); Eric Woods, Durham, NC (US)

(73) Assignee: INTERNATIONAL BUSINESS MACHINES CORPORATION, Armonk, NY (US)

(21) Appl. No.: 13/661,147

(22) Filed: Oct. 26, 2012

(51) Int. Cl. H04N 21/442

(52) U.S. Cl. 725/14

(57) ABSTRACT

A method and a computer program product are disclosed for managing the display of content from a content feed. In one embodiment, a content feed includes a dynamically-generated set of content items electronically fed to one or more device. A priority content item is identified along with a plurality of other content items related by subject matter to each other and to the priority content item. A display status of the priority content item is then monitored, indicating whether the priority content item has been displayed for a user. The visibility of the related content items on the one or more device is controlled according to the display status of the priority content item.

### BACKGROUND OF THE INVENTION

1. Field of the Invention

The present disclosure relates to managing the display of multimedia content provided over various electronic mediums, such as digital television and the Internet.

2. Background of the Related Art

The advent of the personal computer (PC) in the latter half of the twentieth century led to the widespread use of electronic devices to digitally store and process information. The technologies used in computers and other electronic devices have continued to advance. Increasing miniaturization and related improvements in memory density and processor speed, along with vastly improved electronic displays and user input peripherals, have led to the development of many different electronic consumer products. Modern electronic devices are now capable of storing large amounts of information in digital form. Popular electronic devices that incorporate modern computer technologies include personal computers, smartphones, tablet computers, e-readers, digital music players, digital television consoles, and electronic game consoles. These devices are capable of rendering a variety of digital multimedia content, such as audio and video files, from numerous sources.

Modern consumer electronic devices can now communicate and receive digital multimedia content over many different transmission mediums, including Internet, wireless telephone, digital television and satellite networks, local area networks, and personal area networks. The Internet, in particular, is a vast global system of computer networks over which electronic devices are connected. This network of networks is linked by a broad array of electronic, wireless, and optical networking technologies that can move information packets across networks from a source to a destination. A user may access the Internet using any of a variety of different devices such as a laptop or desktop personal computer (“PC”), a tablet computer, or a smartphone, on any of the wired, wireless, and mobile connections currently available.

The Internet carries information resources and services, such as electronic mail (e-mail), instant messaging, telephone services, digital streaming home media content, and the World Wide Web (“Web”). A website is a collection of related web pages on the Web, which is hosted on one or more web servers and accessible via the Internet. Websites on the Internet can be manually accessed by a variety of user devices using a software application known as a web browser. A web browser includes a graphical user interface for displaying multimedia content including audio, video, and still images. Website content includes news, entertainment, shopping, research, and just about any other content type that a person may want to access. A user can access this information manually, such as by using controls on a web browser to browse websites. Content may also be automatically retrieved and provided to a user device, such as using a Rich Site Summary (RSS) web feed.

### BRIEF SUMMARY OF THE INVENTION

One embodiment provides a method comprising generating a content feed. The content feed comprises a dynamically-generated set of content items electronically fed to one or more device for selectively displaying on the one or more device. A priority content item and a plurality of related content items in the content feed are identified, wherein the plurality of related content items include subject matter that is common with the priority content item. A display status of the priority content item is monitored indicating whether the priority content item has been displayed for a user. The visibility of the related content items on the one or more device is then controlled according to the display status of the priority content item.

Another embodiment provides a computer program product including computer usable program code embodied on a computer usable medium for controlling the display of a content feed. The computer program product comprises computer usable program code for monitoring a content feed comprising a dynamically-generated set of content items electronically fed to one or more device for selectively displaying on the one or more device, computer usable program code for identifying a priority content item and a plurality of related content items in the content feed related by subject matter to each other and to the priority content item, computer usable program code for monitoring a display status of the priority content item indicating whether the priority content item has been displayed for a user, and computer usable program code for controlling the visibility of the related content items on the one or more device according to the display status of the priority content item.

### BRIEF DESCRIPTION OF THE SEVERAL VIEWS OF THE DRAWINGS

FIG. 1 is a schematic diagram of a content management system wherein content from multiple content sources is aggregated into a content feed for selective access and display on one or more electronic devices.

FIG. 2 is a schematic diagram of the content management system of FIG. 1 showing an expanded view of the user devices.

FIG. 3 is a flowchart outlining a method of managing the display of content.

### DETAILED DESCRIPTION OF THE INVENTION

A system and method are disclosed for managing the visibility of electronic content in a content feed based on the display status of related content. The visibility of a content item refers to whether a content item capable of being displayed on a device is currently permitted to be displayed on that device. The content may be provided over a plurality of different transmission mediums, including but not limited to the Internet. In one embodiment, various electronic content items are combined into an aggregated content feed. The content may include television content, which may be displayed as it is being broadcast or played back as a digital recording of a previously-received broadcast. The content feed may be aggregated from more than one source, including non-television content sources. Examples of content include dynamically updated website content, an automatically-generated e-mail or text message, and an online radio broadcast. The aggregated content feed may include a web feed, such as an RSS web feed. A plurality of different electronic devices may be associated with a user account. The content feed may be associated with the user, such as by a user subscription to one or more content feeds. Each item of content in the content feed may be individually accessed by one or more of the devices. For example, an RSS feed may be sent to or retrieved by a PC and/or smartphone associated with the user account. Most preferably, the content is digital content following one or more digital data format or standard.

The display of the various content items in the content feed may be controlled according to subject matter. In one embodiment, the method includes identifying the subject matter of each content item and determining a subset of content items that are related based on the subject matter. The display of one content item may be controlled according to the display status of a related content item, i.e. whether the related content item has already been displayed for a user. Devices may automatically mine the display statuses of content on other devices. One or more priority content item may be identified to avoid a deadlock that may otherwise occur when none of the related content items have yet been displayed. The priority content item may be automatically designated, such as the first (oldest) content item in a set of related content items to be affirmatively selected for viewing. Alternatively, the priority content item may be designated according to a first-in-time rule, or manually designated by a user or by a content provider. With the related content and the priority content item having been determined, the rendering of related content on the devices may be controlled according to the display status of the priority content item. For example, news or commentary having the same subject matter as the priority content item may be blocked until the priority content item has been displayed for a user.

In a practical application, the method may be applied to avoid the possibility of so-called “spoilers” wherein someone inadvertently learns the score of a televised sporting event (i.e. a “game”), which may have already completed, before the person has had a chance to view the game. Applying an embodiment of the disclosed method, an original television broadcast of the game and/or a DVR recording of the television broadcast of the game may be selected as priority content items. A subset of related content from the aggregated content feed may include a television highlights program discussing details of the game, a website news feed discussing the game, and a text message alert about a score of the game. The visibility of the related content may be blocked unless and until the display status of either of the priority content items indicates that the priority content item(s) has/have been displayed for the user. Once the display status of the game has an affirmative value, then the other related content in the aggregated news feed, such as the highlights program or website news feed, may be unblocked.

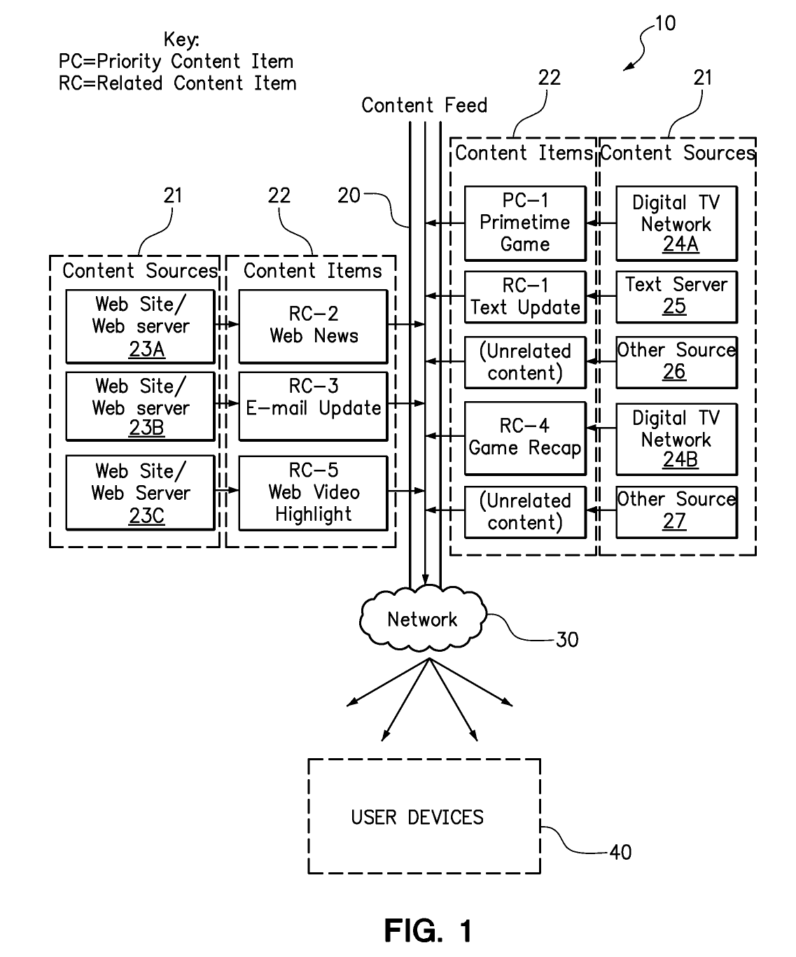

FIG. 1 is a schematic diagram of a content management system 10 wherein content from multiple content sources 21 is aggregated into a content feed 20 for selective access and display on one or more electronic devices 40. Individual content items 22 provided to the content feed 20 are provided to the devices 40 over a plurality of different transmission mediums. The transmission mediums in this example include Internet, mobile telephone, and satellite. Content may be transmitted over these mediums according to a predefined or standardized communication protocol. For example, Internet traffic may be provided using an Internet protocol, mobile telephone content may be provided over a digital telecommunications network, and satellite content may be provided over a satellite communication protocol. The mediums are collectively referred to as the network 30. Two-way communication mediums and protocols may be used to transmit content both to and from the devices 40, but each of the transmission mediums at least allows for the transmission of content from the respective content source 21 to the devices 40. The various content items may be automatically transmitted via the content feed 20 to the devices 40 as the content becomes available. Alternatively, the content sources 21 may initially publish the availability of the content over the feed 20, for the devices 40 to access as needed. The content items 22 in the content feed 20 are graphically arranged in chronological order from top to bottom, with the most recently available content item 22 at the bottom.

The content feed 20 may be aggregated from more than one content source 21 and from more than one type of content source 21. Here, for example, the content sources 21 include one or more web servers 23 individually referenced at 23A, 23B, 23C, one or more digital television networks 24 individually referenced at 24A, 24B, an SMS (text) server 25, and other sources 26, 27 such as satellite broadcasters. The aggregated content feed 20 may also comprise more than one separate content feed. For instance, content from the web servers 23 may be provided separately to the aggregated content feed 20 using a web feed or scraper. A web feed and a scraper are two types of protocols used to automatically retrieve content from each web site/server 23. A web feed is usually provided on the web server hosting a website, whereas a scraper is usually an external entity that accesses and retrieves content from a web server.

A web feed may include a regularly updated summary of web content automatically delivered to a client device 40 (e.g. a personal computer or smartphone). RSS (Rich Site Summary) is a widely-used family of web feed formats. A web feed can be used to publish frequently updated works such as blog entries, news headlines, audio, and video, in a standardized format. Content distributors syndicate their web feeds, thereby allowing users to subscribe to the web feeds. A separate web feed may be provided for each website 23, to which the devices 40 can be registered with an aggregator program such as a feed reader or a news reader running on one or more of the devices 40. When new content is available in the feed list, the aggregator either makes a note of the new content or downloads it, providing it to the content feed 20. A scraper may alternatively be used to obtain the content from the web servers 23. In web scraping (i.e. web harvesting or web data extraction), a software program external to the web server hosting the content obtains the content, such as by implementing a low-level Hypertext Transfer Protocol (HTTP).

A subset of content items 22 in the content feed 20 are related by subject matter. To determine which content items 22 are related by subject matter, a text-based description of each content item in the content feed 20 may be analyzed to identify the subject matter of each content item. For example, the analysis may include natural language processing of the description of content and metadata. Then, the subject matter of each content item may be compared to determine the set of related content items 22. In this example, the broadcast of the Primetime Game may include some text-based description containing keywords, such as the official name of the game. The related content may also include some text-based description containing some of the same keywords. In some contexts, the text-based description may be referred to as metadata.

The visibility of each content item, i.e. the ability of a device 40 to display or otherwise render the content item, may be controlled according to the display status of other, related content items 22. The term rendering encompasses both displaying visual components of content such as text, images, and video, and playing back any audio components of content. For example, news or commentary having the same subject matter as the priority content item may be blocked until the priority content item has been displayed for a user. One or more priority content item may be identified to avoid a deadlock that may otherwise occur when none of the related content items 22 have yet been displayed. The priority content item may be automatically designated, such as according to a first-in-time rule, wherein the first in a series of related content items 22 made available to the content feed 20 is selected as a priority content item. Alternatively, one or more priority content item may be manually designated by a user or by a content provider. The related content items 22 in this example include a priority content item labeled PC-M and one or more other related content items 22 labeled RC-N (where M and N are just integers used in the figure to distinguish the different content items). By way of example, a Primetime Game is the priority content item PC-1, which may be broadcast “live” and displayed as soon as it has been received by one of the devices 40. The related content items 22, listed in the order in which they are made available to the content feed 20, include: a text update (RC-1) of the game, which may include a score; a web news segment (RC-2) discussing the game; an e-mail update (RC-3) that may list a current score or player stats; a television game recap (RC-4) that may include a second airing of the game along with some embedded commentary; and some web video highlights (RC-5).

A variety of different selection criteria may be used to select the priority content item(s). In this hypothetical case, the Primetime Game is designated as a priority content item (PC-1) because it is the first content item to be made available to the content feed 20. However, in another embodiment, the first available content item in a feed is not necessarily the priority content item. For example, a pre-game show may be made available to the content feed 20 earlier in time than the Primetime Game. Also, a priority content item may be established without regard to the order in which it was originally made available to the content feed 20. In an alternative embodiment, the priority content item could be established by having either the user associated with the user devices 40 or one of the content providers select a priority content item. Also, although there is only one content item in this example, it is possible for more than one priority content item to be established for a set of related content. As further discussed below, the display of a particular content item from the content feed 20 may be controlled according to the display status of another, related content item. In particular, the display status of the designated priority content item(s) may be controlling. A device that receives a content item or a notice of the availability of the content item in the content feed 20 may poll the priority content item. If the display status of the priority content item (e.g. the original airing or a DVR recording of the Primetime Game) indicates that the priority content item has not yet been displayed for a user, then the visibility of the related content item(s) may be automatically blocked.

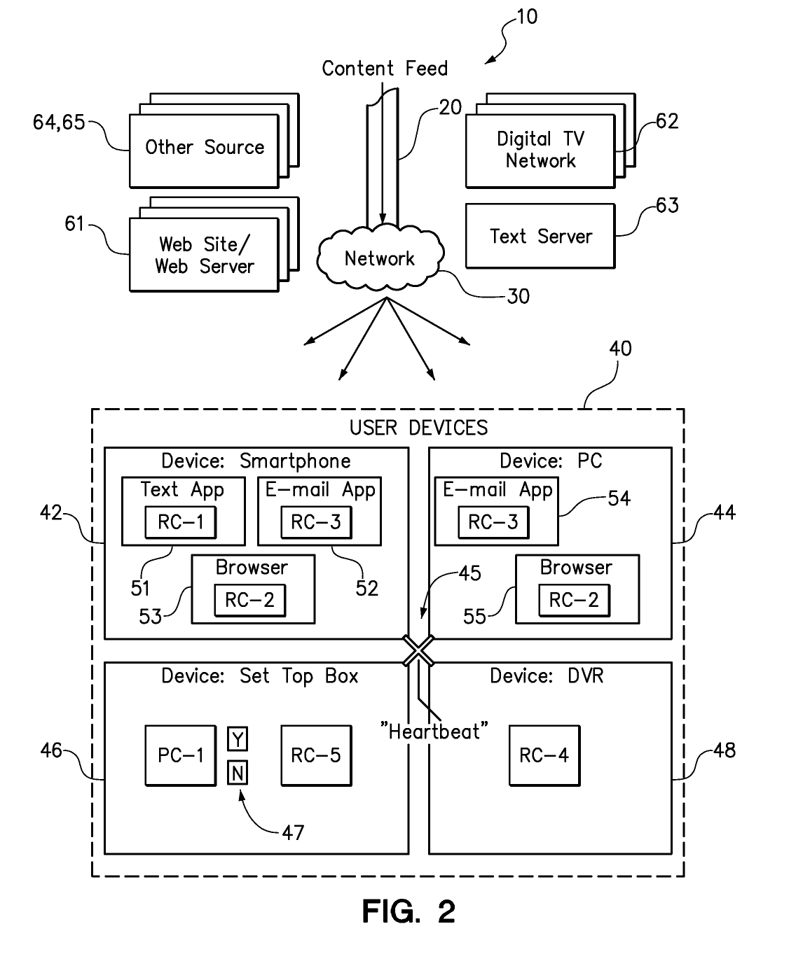

FIG. 2 is a schematic diagram of the content management system 10 showing an expanded view of the user devices 40. The user devices 40 are a set of electronic devices associated with a user. By way of example, these devices 40 include a smartphone 42, a personal computer (“PC”) 44, a digital television receiver (“Set Top Box”) 46, and a digital video recorder (DVR) 48. The smartphone 42 may be associated with the user by virtue of a mobile telephone service account and unique phone number. The PC 44 may be associated with the user by virtue of an Internet service account with an Internet connection provided to the PC 44. Accordingly, the PC may be assigned a certain IP address. The digital television receiver 46 may be associated with the user by virtue of a digital television account with digital television service provided to the receiver 46. The DVR 48 may also be associated with the user by virtue of its connection with the digital television receiver 46 for selectively recording digital broadcasts received by the receiver 46. Some of the content in the content feed 20 is provided to and received by the various devices 40. The user manages these different devices and the associated service accounts.

Each of the user's devices 40 includes hardware and software for receiving and selectively displaying one or more type of content available over the content feed 20. The digital receiver 46 includes hardware and firmware for digitally decoding television content from a digital TV network 62 and displaying the content on a conventional electronic display (not shown). The DVR 48 includes firmware for recording selected television content received by the digital receiver 46, and may also selectively play back the recorded television content for display to the same or another electronic display. The smartphone 42 and PC 44 include various software applications (“apps”) capable of displaying content. The smartphone 42 includes a text app 51 for displaying text messages from the text server 63, an e-mail app 52 for displaying e-mail messages which may be from the web servers 61 or another server, and a web browser 53 for displaying web content from the web servers 61. Likewise, the PC 44 includes an e-mail app 54 and a web browser 55.

Each content item in the feed is capable of being displayed on or through at least one of the devices 40. Although not required, a particular content item may be addressed (or otherwise directed) to a specific device 40, such as through any suitable addressing methods, or by virtue of a connection to that device. For example, the dynamically updated content from the web servers 61 may be transmitted in the content feed 20 and displayed on the browser 53 of the smartphone and the browser 55 of the PC. The digital television content broadcast by the digital TV network 24 may be received by the digital receiver 46 and displayed as it is received. The DVR 48 may record selected portions of the digital television content as it is received by the digital receiver 46, for subsequent playback. In one non-limiting example, the specific content items PC-M and RC-N are indicated on the particular devices capable of rendering those content items. Some content items may be rendered by more than one device. For example, the e-mail update (content item RC-3) is capable of being displayed on the e-mail app 52 on the smartphone 42 and the e-mail app 54 on the PC 44.

The system 10 is capable of managing the visibility of the various content items according to the viewing status of one or more of the related content items. By way of example, a display status register 47 on the digital TV receiver 46 is used to indicate the display status of the priority content item PC-1, represented in the figure as Yes/No (Y/N) boxes. Similar display status registers (not shown) may also be provided on the other devices 40. The visibility of a particular content item capable of being displayed on a device refers to whether that content item is currently allowed to be displayed. Whether a particular content item is currently displayable is determined by the system 10 according to the display status of one or more other content items in the feed 20. To facilitate managing the visibility of the related content items, the devices 40 communicate with one another over a device communication interface 45. This interface 45 comprises a shared “heartbeat” (a polling mechanism configurable by the user) that allows each device 40 to keep track of the display statuses of the content items. As related content items become available in the content feed 20, a device 40 to which a particular content item is directed may poll the other devices 40 to see if those other devices have received any related content items and, if so, to obtain the display status of those related content items.

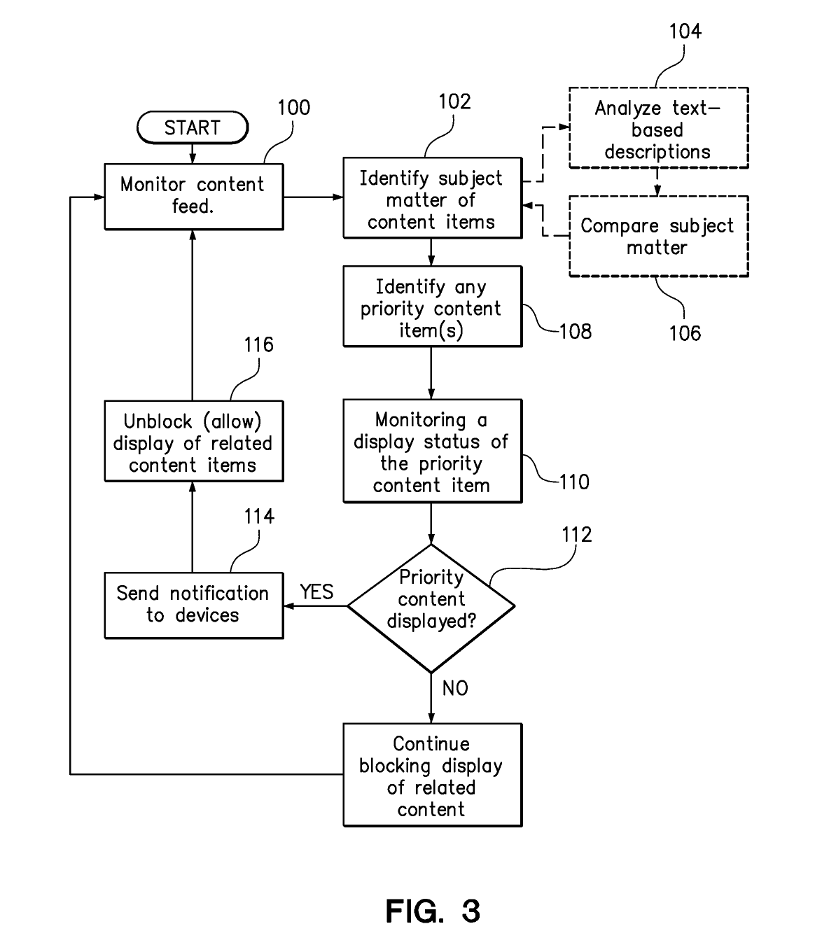

FIG. 3 is a flowchart outlining a method of managing the display of electronic content. The method may be implemented by a system of user devices, such as the system 10 of FIGS. 1 and 2. According to step 100, a content feed is monitored. The content feed may be a single content feed, such as a web feed. Alternatively, the content feed may be aggregated from a plurality of different content sources and content feeds, such as an RSS web feed in combination with a digital television broadcaster, a digital or satellite radio broadcaster, a digital telephone network, and the like. The content feed may include both notifications of available content as well as actual content being transmitted on the respective transmission medium.

The subject matter of the content items is identified per step 102. An example subroutine for determining the subject matter is outlined in steps 104 and 106. Per step 104, text-based descriptions attached to or associated with the content items may be analyzed. In step 106, the subject matter of the content items obtained in step 104 is compared to identify related content items. The comparison may reveal identical or similar keywords, for example. Natural language processing may be used to analyze the text descriptions per step 104 and to compare these text descriptions per step 106.

Step 108 is to identify any priority content item(s). The priority content item may be controlling as to whether other, related content items are allowed to be displayed. The establishment of a priority content item may be used as a reference for determined whether other related content items may be displayed. The establishment of a priority content item thereby avoids deadlocks. The priority content item may be established by a rule, such as a first-in-time rule. Alternatively, the priority content item may be established by a user or by a content provider.

Step 110 is to monitor the display status of the priority content item(s), i.e., whether the priority content item has been displayed. For example, if an item of digital television content is designated as a priority content item, a digital receiver (i.e. set top box) that receives the digital television content may monitor whether a substantial portion of the digital television content has actually been output to a display device such as an LCD display. The receiver may keep track of the display status of a priority content item and any other content items using a display status register or otherwise store the display status in memory. A recording device such as a DVR may record the digital television content that was designated as the priority content item. The DVR may then also track whether the priority content item has been displayed by the DVR. The display status of the priority content may default to “not-viewed”, and is switched to “viewed” after the content item or a substantial portion thereof has been displayed.

Conditional step 112 is then to determine whether the priority content item has been displayed. This determination may be performed by a device prior to that device displaying a related content item. The related content item or a notification of the availability of the related content item may be provided to the device over the content feed. In response, the device may poll other devices to see if any of the other devices have yet displayed the priority content item. Alternatively, a device that displays the priority content item for a user may then notify the other devices of the changed display status of the priority content item per step 114. The visibility of the priority content item may be blocked by default, and unblocked per step 116 in response to the priority content item having been displayed. The method continues, with each item of content being examined to determine its relatedness to other content items, and to control the visibility of the related content items.

As will be appreciated by one skilled in the art, aspects of the present invention may be embodied as a system, method, computer-implemented method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-11. (canceled)

12. A computer program product including computer usable program code embodied on a non-transitory computer readable medium for controlling the display of a content feed, the computer program product including:
computer usable program code for monitoring a content feed comprising a dynamically-generated set of content items electronically fed to one or more device for selectively displaying on the one or more device;
computer usable program code for identifying a priority content item and a plurality of related content items in the content feed related by subject matter to each other and to the priority content item;
computer usable program code for monitoring a display status of the priority content item indicating whether the priority content item has been displayed for a user; and
computer usable program code for controlling the visibility of the related content items on the one or more device according to the display status of the priority content item.

13. The computer program product of claim 12, further comprising:
computer usable program code for blocking the related content items from being displayed until the display status of the priority content item indicates the priority content item has been displayed;
computer usable program code for sending a notification to the one or more device in response to the priority content item having been displayed for the user; and
computer usable program code for unblocking the related content items in response to receiving the notification.

14. The computer program product of claim 12, further comprising:
computer usable program code for analyzing a text-based description of each content item in the content feed to identify the subject matter of each content item; and
computer usable program code for comparing the subject matter of each content item to determine the related content items.

15. The computer program product of claim 14, further comprising:
computer usable program code for performing natural language processing to analyze the text-based description of each content item in the content feed to identify the subject matter of each content item.

16. The computer program product of claim 12, further comprising:
computer usable program code for receiving a particular one of the content items at a particular one of the devices;
computer usable program code usable by the particular device for polling the other devices to determine if a content item related to the particular content item has been displayed on one of the other devices; and
computer usable program code for setting the related content item as the priority content item if the related content item has been displayed, and controlling the visibility of the particular content item to allow the particular device to display the particular content item.

17. The computer program product of claim 12, further comprising:
computer usable program code for identifying the plurality of related content items related by subject matter to each other prior to identifying the priority content item; and
computer usable program code for prompting for user input to select one of the related content items as the priority content item in response to identifying the plurality of related content items, without displaying the related content items.

18. The computer program product of claim 12, wherein the computer usable program code for identifying the priority content item comprises:
computer usable program code for setting the priority content item as a first of the related content items to be fed to the one or more device.
